(19) United States
(12) Patent Application Publication
(10) Pub. No.: US 2010/0308242 A1
(43) Pub. Date: Dec. 9, 2010

(54) Actuator for Actuating a Valve Flap in a Valve Seat

(75) Inventor: Rosario Bonanno, Bad Soden (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/808,497

(22) PCT Filed: Dec. 18, 2008
(86) PCT No.: PCT/EP2008/067892

§ 371 Date: Jun. 16, 2010

(30) Foreign Application Priority Data
Dec. 21, 2007 (DE) 10 2007 061 996.2

(51) Int. Cl. F16K 31/02

(52) U.S. Cl. 251/129.11

(57) ABSTRACT

In an actuator, an electric motor having a pinion is disposed, which engages directly in the teeth of a gear wheel having spline teeth, which is fixedly connected directly to the drive shaft, on which the valve flap is disposed. A use of the actuator for actuating an exhaust gas recirculation valve of a motor vehicle.

### PRIORITY CLAIM

This is a U.S. national stage of Application No. PCT/EP2008/067892, filed on Dec. 18, 2008, which claims priority to the German Application No.: 10 2007 061 996.2, filed: Dec. 21, 2007, the contents of both are incorporated herein by reference.

### BACKGROUND OF THE INVENTION

1. Field of the Invention

The invention relates to an actuator for actuating a valve flap in a valve seat. Furthermore, the invention relates to the use of the actuator.

2. Related Art

Actuators for actuating valve flaps in valve seats are known.

DE 10 2005 051 304 A1 describes a method for cleaning contaminants between a valve flap and a valve seat. The actuator has a first tooth segment and a second tooth segment that are in engagement with one another. Here, both tooth circles of the tooth segments have radii which can be changed with respect to one another in the opposite direction, with the result that different torques can be set during operation. The tooth circle of the first tooth segment and the tooth circle of the second tooth segment do not extend circularly, but rather spirally, it being possible for different types of spiral sections to be provided behind one another. In actuators of this type, it is as a rule disadvantageous that a plurality of gear mechanism parts or tooth segments have to be arranged, which makes a relatively large amount of installation space necessary for the actuator.

### SUMMARY OF THE INVENTION

The invention is therefore based on providing an actuator for actuating a valve flap in a valve seat, which actuator makes a relatively small amount of installation space necessary. Furthermore, the invention is based on the object of providing a use of the actuator.

An object on which the invention is based is achieved by an actuator for actuating a valve flap in a valve seat, in which an electric motor is arranged with a pinion that engages directly into the toothing of a gearwheel that has spur toothing and is fixedly connected directly to the drive shaft, on which the valve flap is arranged. Here, for example, a tooth segment can be used as gearwheel. In addition to the valve flaps which can be configured differently, the designation valve flap includes throttle valves of throttle valve housings. It has been shown that an actuator is suitable for actuating a valve flap in a valve seat even when the pinion of the electric motor engages directly into the spur toothing of a gearwheel which is connected directly to the drive shaft of the valve flap, and the arrangement of additional gear mechanism parts, such as additional tooth segments, is therefore dispensed with. The actuator is therefore eminently suitable in an advantageous manner for actuating valves if only a small amount of installation space is available.

One preferred embodiment of the invention comprises the spur toothing of the gearwheel being arranged so as to extend, in a plan view of the gearwheel, in a spiral shape from the outside to the inside. Here, the spiral is to be understood to mean a curve that extends about a central point or a central axis and, depending on the running direction, moves further and further away from the former or approaches more and more closely to the former. The expression “spiral” is therefore not restricted to specific spiral types. It is advantageous here that different types of torque, by which the valve flap is actuated accordingly, can be set in a relatively simple way during the actuation of the valve flap. Therefore, for example, a greater starting torque and a smaller end torque can be set by the spiral formation of the spur toothing. Here, the starting torque is understood to be that torque which acts on the drive shaft at the beginning of operation, the valve flap being situated in the position of the closed valve. Here, the end torque is to be understood as that torque which acts finally on the drive shaft at the end of operation, the valve flap being situated in the open position of the valve. It is particularly advantageous here that contaminants between the valve flap and the valve seat can be virtually completely removed solely by loading the driveshaft with the corresponding torques. This is advantageously possible although the arrangement of additional tooth segments or additional gear mechanism parts is dispensed with. Here, the use of cleaning agents or mechanical cleaning apparatuses can be dispensed with completely. The actual magnitudes of the torques are dependent on the valve size and are determined by an engineer.

According to one embodiment of the invention, the ratio between the first spacing R1 between the longitudinal axis of the drive shaft and the flank center of the outermost flank F1 of the spur toothing, which first spacing R1 is assigned the closed position of the valve flap, and the second spacing R2 between the longitudinal axis of the drive shaft and the flank center of the innermost flank F2 of the spur toothing, which second spacing R2 is assigned the open position of the valve flap, lies in the range from 1.6 to 2. The outermost flank F1 is understood as that flank which, during operation, is at the greatest spacing from the longitudinal axis of the drive shaft. The innermost flank F2 is understood as that flank which, during operation, is at the smallest spacing from the longitudinal axis of the drive shaft. If the ratio between the first spacing R1 and the second spacing R2 lies in the range from 1.6 to 2, it is also ensured after long operating times of the valve that contaminants between the valve flap and the valve seat are removed virtually completely, it being possible to dispense with additional cleaning processes.

The subject matter of the invention is, furthermore, the use of the actuator for actuating an exhaust gas recirculation valve of a motor vehicle. As a rule, only a very restricted amount of installation space is available for actuators for actuating an exhaust gas recirculation valve of a motor vehicle. On account of the compact design of the actuator, its use as actuator for actuating an exhaust gas recirculation valve of a motor vehicle is particularly advantageous.

### BRIEF DESCRIPTION OF DRAWINGS

In the following text, the invention will be explained in greater detail and by way of example using the drawings, in which:

FIG. 1 is a perspective view of an actuator with valve flap in a valve seat;

FIG. 2 is a plan view of a tooth segment which is arranged as a gearwheel and has spirally arranged spur toothing;

FIG. 3 is the actuator in side view with the valve flap in a closed position; and

FIG. 4 is the actuator in side view with the valve flap in an open position.

### DETAILED DESCRIPTION OF THE DRAWINGS

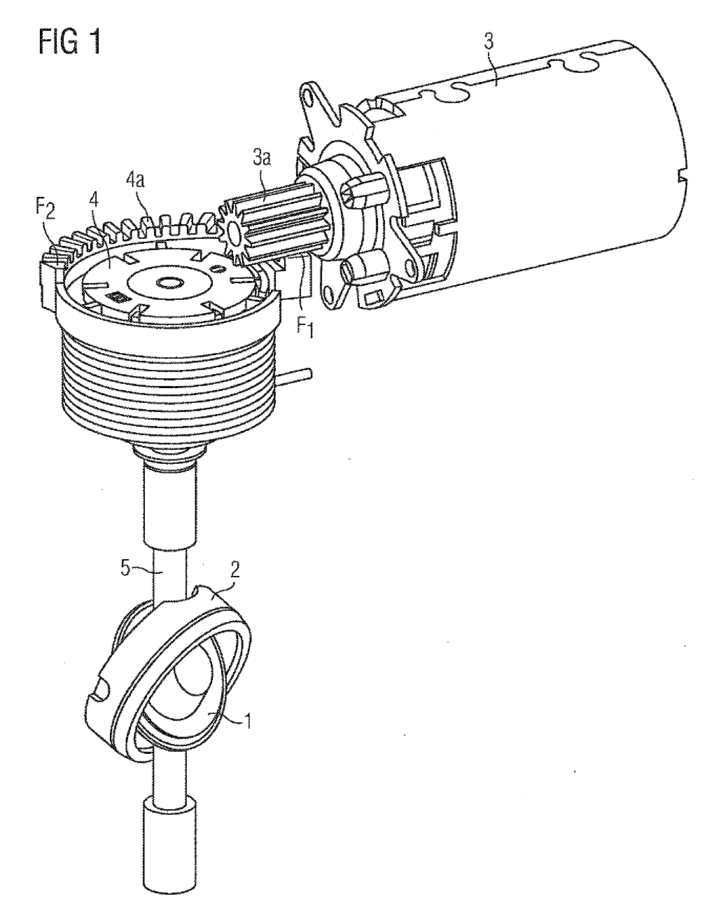

FIG. 1 is an actuator for actuating a valve flap 1 in a valve seat 2 in three dimensions. In the actuator, an electric motor 3 is arranged with a pinion 3a which engages directly into the toothing of a gearwheel 4 with spur toothing 4a. Here, a tooth segment is arranged as gearwheel 4 with regard to the spur toothing 4a. The gearwheel 4 is connected directly to the drive shaft 5, on which the valve flap 1 is arranged. Advantageously, no additional gear mechanism parts or tooth segments are arranged between the electric motor 3 and the gearwheel 4, as a result of which the actuator is of relatively compact design and requires only a relatively small amount of installation space. The valve flap 1 is situated in the closed position in the valve seat 2. In this position, the pinion 3a of the electric motor 3 is directly in engagement by way of the spur toothing 4a with the outermost flank F1 of the spur toothing 4a.

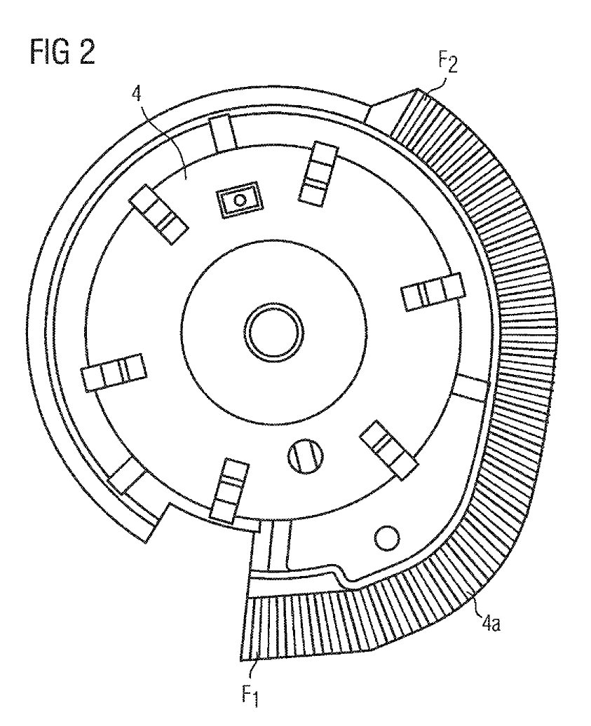

FIG. 2 is a plan view of the gearwheel 4 with the spur toothing 4a which extends spirally from the outside to the inside. With regard to the spur toothing 4a, the gearwheel 4 is a tooth segment. The spur toothing 4a has an outermost flank F1 and an innermost flank F2 which are in each case at a different spacing from the rotational axis of the gearwheel 4. The spiral course of the spur toothing 4a ensures in a relatively simple way that, during the operation of the valve, different torques can act on the drive shaft 5. This is of great significance, in particular, with regard to the cleaning of contaminants between the valve flap 1, and the valve seat 2.

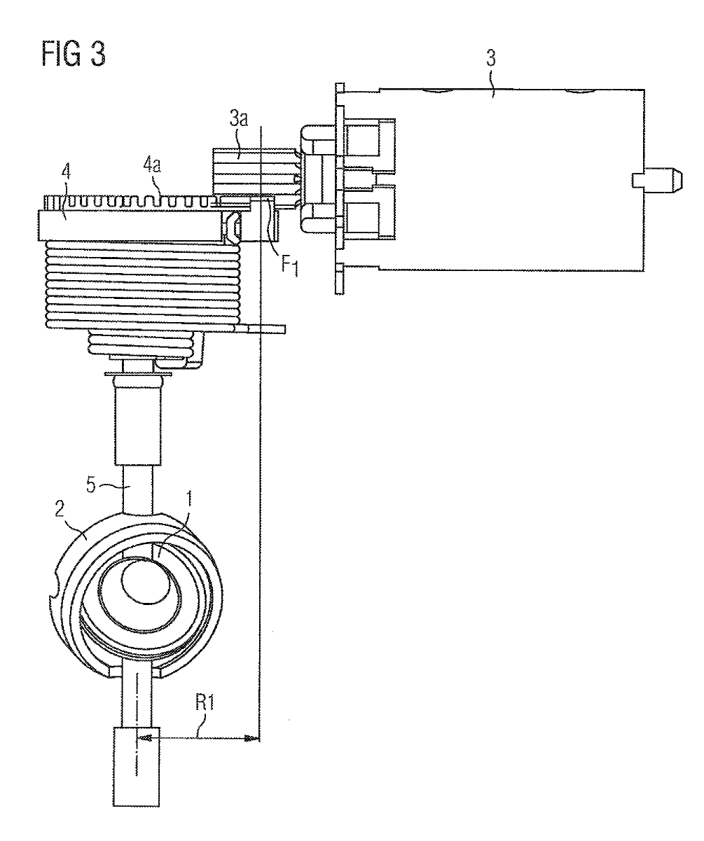

FIG. 3 is a side view of the actuator for actuating a valve flap 1 in a valve seat 2. Here, the valve flap 1 is situated in the closed position analogously to FIG. 1, and the pinion 3a is in engagement via the outermost flank F1 with the spur toothing 4a. In this position, the first spacing R1 is realized between the longitudinal axis of the drive shaft 5 and the flank center of the outermost flank F1 of the spur toothing 4a which first spacing R1 is assigned the closed position of the valve flap 1. If, starting from this position, the electric motor 3 is then actuated correspondingly, the pinion 3a leaves the outermost flank F1 and migrates correspondingly on the spur toothing 4a, as a result of which the valve flap 1 opens slowly in a manner induced by the greater torque. This slow opening of the valve flap 1 brings about advantageous cleaning of the contaminants between the valve flap 1 and the valve seat 2. During continuous operation of the electric motor 3, the first spacing R1 is reduced further until finally the second spacing R2 is set.

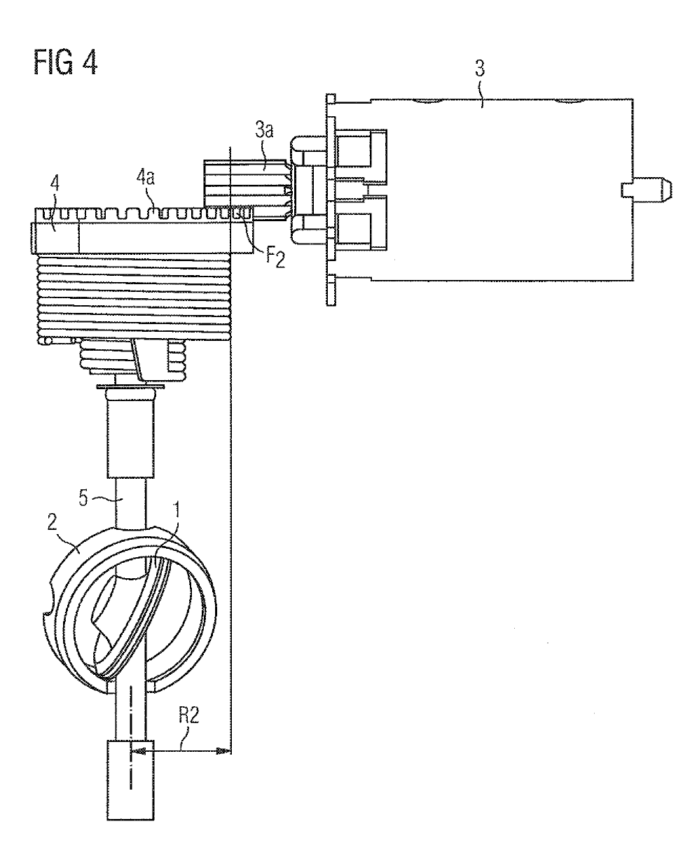

FIG. 4 is a side view of the actuator for actuating a valve flap 1 in a valve seat 2, with a completely open valve flap 1. In this position, the pinion 3a of the electric motor 3 is in engagement via the innermost flank F2 with the spur toothing 4a. The second spacing R2 between the longitudinal axis of the drive shaft 5 and the flank center of the innermost flank F2 of the spur toothing 4a, which second spacing R2 is assigned the open position of the valve flap 1, is smaller than the first spacing R1 shown in FIG. 3 so that a smaller torque acts on the drive shaft 5 in the region of the open position of the valve flap 1, which results in lower actuating times of the valve. The lower actuating times are also desired in this position, since the aim in this position is no longer the cleaning of contaminants between the valve flap 1 and the valve seat 2, but rather as rapid an actuation of the valve as possible. The actuator is particularly advantageously suitable for actuating an exhaust gas recirculation valve of a motor vehicle, since it is of compact design, operates reliably over relatively long operating times and requires only a small amount of installation space for its arrangement.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. An actuator for actuating a valve flap in a valve seat, comprising:
a gearwheel having spur toothing;
a pinion that engages directly into the spur toothing of the gearwheel;
an electric motor configured to drive the pinion; and
a drive shaft fixedly connected to the gear wheel on which the valve flap is arranged.

6. The actuator as claimed in claim 5, in which the spur toothing of the gearwheel is arranged to extend, in a plan view of the gearwheel, in a spiral shape.

7. The actuator as claimed in claim 6, further comprising
a first spacing between a longitudinal axis of the drive shaft and a flank center of an outermost flank of the spur toothing, the first spacing corresponding to a closed position of the valve flap, and
a second spacing between the longitudinal axis of the drive shaft and a flank center of an innermost flank of the spur toothing, the second spacing corresponding to an open position of the valve flap,
wherein a ratio between the first spacing and the second spacing is in the range from 1.6 to 2.

8. The actuator as claimed in claim 5, wherein the actuator is configured to actuate an exhaust gas recirculation valve of a motor vehicle.

9. The actuator as claimed in claim 6, in which the spiral shape extends from an outside of the gearwheel to an inside of the gearwheel.

10. The actuator as claimed in claim 6, further comprising
a first spacing between a longitudinal axis of the drive shaft and a flank center of an outermost flank of the spur toothing, the first spacing corresponding to a closed position of the valve flap, and
a second spacing between the longitudinal axis of the drive shaft and a flank center of an innermost flank of the spur toothing, the second spacing corresponding to an open position of the valve flap,
wherein a ratio between the first spacing and the second spacing is at least about 1.6.

11. The actuator as claimed in claim 6, further comprising
a first spacing between a longitudinal axis of the drive shaft and a flank center of an outermost flank of the spur toothing, the first spacing corresponding to a closed position of the valve flap, and
a second spacing between the longitudinal axis of the drive shaft and a flank center of an innermost flank of the spur toothing, the second spacing corresponding to an open position of the valve flap,
wherein a ratio between the first spacing and the second spacing is less than about 2.

12. The actuator as claimed in claim 7, wherein the actuator is configured to actuate an exhaust gas recirculation valve of a motor vehicle.

13. The actuator as claimed in claim 5, wherein the drive shaft is directly connected to the gear wheel.
